(19) United States
(12) Patent Application Publication
(10) Pub. No.: US 2010/0217623 A1
(43) Pub. Date: Aug. 26, 2010

(54) Decision Support

(76) Inventors: Ido Schoenberg, Boston, MA (US); Eran David, Tel-Aviv (IL)

Correspondence Address: FISH & RICHARDSON PC, P.O. BOX 1022, MINNEAPOLIS, MN, 55440-1022, US

(21) Appl. No.: 12/713,829

(22) Filed: Feb. 26, 2010

Related U.S. Application Data
(60) Provisional application No. 61/155,744, filed on Feb. 26, 2009.
(60) Provisional application No. 61/175,162, filed on May 4, 2009.

(51) Int. Cl. G06Q 50/00

(52) U.S. Cl. 705/3; 235/380

(57) ABSTRACT

Among other things, a computer implemented method includes receiving a unique patient identifier for a patient. The method also includes using the unique patient identifier to retrieve medical information associated with the patient from a centralized information source that includes a patient record containing the medical information. After performing a medical procedure on the patient based on the retrieved medical information, the method includes updating the patient record in the centralized information source to reflect the performed medical procedure.

### CROSS REFERENCE TO RELATED APPLICATIONS

Pursuant to 35 USC §119(e), this application claims the benefit of prior U.S. Provisional Application 61/155,744, filed Feb. 26, 2009, and Provisional Application 61/175,162, filed May 4, 2009, both of which are incorporated by reference in their entirety.

### BACKGROUND

This disclosure relates to documenting medical information for supporting healthcare professionals.

Patient information is often acquired and made available to members of a healthcare facility (e.g., hospital staff) when a patient is admitted into the healthcare facility (for simplicity, referred to as a hospital). Generally, such information can include patient identity, address, age, occupation, next of kin, medical history, conditions for which treatment is sought, preexisting conditions, medical insurance information, and the like. While in the hospital, the patient information can be dynamically changed or appended with additional information relating to their stay (e.g., observations and remarks from doctors or nurses, laboratory reports, diagnoses, treatment orders, prescription, administration schedule, and etc.). With more and more visits from patients, the volume of patient information can grow at an alarming rate and create a significant challenge for the hospital to store, maintain and update patient information.

### SUMMARY

In general, in one aspect, a computer implemented method comprises receiving a unique patient identifier for a patient; using the unique patient identifier to retrieve medical information associated with the patient from a centralized information source that includes a patient record containing the medical information; and after performing a medical procedure on the patient based on the retrieved medical information, updating the patient record in the centralized information source to reflect the performed medical procedure.

Implementations may include one or more of the following features. The method also includes delivering medical information associated with the patient to the centralized information source; and applying one or more rules to the received information to update the delivered medical information associated with the patient. The medical information comprises patient real-time data and patient record data. The method also includes printing the medical information in a machine-readable form. The medical information includes information representative of reactions to an administered drug. The reaction information is represented in a graphical form. The unique patient identifier is received from a barcode scanner. Using the unique patient identifier to retrieve medical information associated with the patient includes decoding the unique patient identifier received from a barcode scanner. Using the unique patient identifier to retrieve medical information associated with the patient includes accessing the centralized information source with the unique identifier.

In another aspect, a system comprises a data reader in communication with a centralized server and a data repository for storing and managing medical information. The data reader is configured to receive a machine-readable patient identifier from at least one device disposed at a location different from the centralized server and the data repository, the data reader being further configured to exchange the medical information with the centralized server and the data repository based on the patient identifier.

Implementations may include one or more of the following features. The data reader is implemented in a portable device. The data reader comprises a data storage; and a processor configured to initiate one or more processes to exchange the medical information with the centralized server and the data repository based on the received patient identifier. The data reader includes a scanner and the machine-readable patient identifier is a barcode.

In another aspect, a computer-readable medium for storing instructions that are executable by a computer is described. The execution of the instructions causes the computer to receive a unique patient identifier for a patient; use the unique patient identifier to retrieve medical information associated with the patient from a centralized information source that includes a patient record containing the medical information; and after performing a medical procedure on the patient based on the retrieved medical information, update the patient record in the centralized information source to reflect the performed medical procedure.

Implementations may include one or more of the following features. The computer also delivers medical information about the patient to the centralized information source; and applies one or more rules to update the medical information based on the delivered information. The medical information includes patient real-time data and patient record data. The computer also prints the medical information in a machine-readable form. The medical information includes possible patient reactions to a drug and drug contradiction information. The possible patient reactions are presented in a graphical form. The unique patient identifier is received by scanning a barcode label on a device remote to the centralized information source. Retrieving the medical information comprises decoding the barcode label or retrieving the information from the centralized information source to display on a scanner based on the unique identifier. Retrieving the medical information comprises accessing the centralized information source with the unique identifier.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates a system for storing and retrieving patient data.

FIG. 2 is a block diagram of a centralized computer server and data repositories.

FIGS. 3 and 4 are flow charts of operations of a medical information system.

FIG. 5 is a block diagram that represents a computer system and related components.

### DETAILED DESCRIPTION

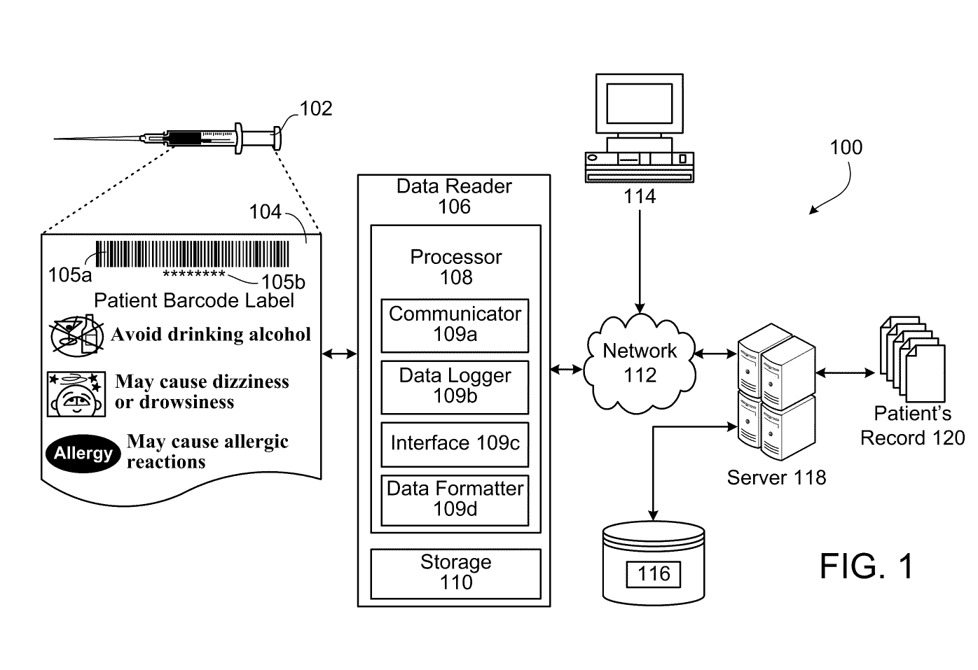

Referring to FIG. 1, a medical information system 100 generates and manages medical information, e.g., patient information, related to healthcare procedures associated with patients, such as administering drugs to a patient or other clinical procedures. The medical information can be stored in a machine-accessible format. In one example, the medical information of a patient is encoded in a patient barcode label 104, together with a patient identifier. In other arrangements, the medical information is stored separate from the barcode label 104 (e.g., a remotely located storage) and is retrievable based on information, e.g., the patient identifier, readable from the barcode label 104. The medical information in the barcode label 104 (or from a separate source) can be read or retrieved, and displayed using, e.g., a data reader 106. In some implementations, the data reader 106 takes the form of a handheld portable device to read, retrieve and use the patient information, e.g., to confirm the content and dosage of the drugs prior to administration. Other information, e.g., information about the drugs, such as side effects, can also be provided on barcode label 104. The barcode label 104 may be affixed to various types of objects associated with healthcare, for example, drug dispensers (e.g., a syringe 102, an infusion bag, and etc.) and other types of medical devices may be affixed with a barcode.

Along with attaining information from a barcode, the data reader 106 can access a centralized computer server 118 (and a data repository 116) via a shared network 112 and retrieve or store medical information into the server 118 or the repository 116. The medical information (e.g., patient information) in the server 118 or the repository 116 can be processed (e.g., sorted) or retrieved based on information read from the barcode label 104. For example, each patient associated with a healthcare facility may have a patient record, which may be identifiable by the patient identifier, that contains the medical information related to this particular patient.

In some arrangement, medical information may be store at multiple locations. For example, patient data may be stored in a distributed manner using the barcode label 104 and the data repository 116 (and the computer server 118). As such, the barcode label 104, which may be attached to various types of medical devices, may or may not include all the medical data pertaining to a patient. For such a situation, upon being read (e.g., scanned by the data reader 106), information provided by the barcode label 104 (e.g., identification of the device to which the barcode is affixed, patient identification, etc.) can be used to identify an associated clinical event (or events) and the appropriate data could be registered in a comprehensive patient file 120. In a particular example, the barcode label 104 may only include a patient identifier and the machine or procedural specifications. After scanning the barcode label 104, the data reader 106 initiates a search to find the patient information in a corresponding patient record in the server 118 and determines whether the medical device or the procedure to be administered matches the information provided by the patient record. Upon a match being identified, one or more events may be triggered. For example, the healthcare profession may be authorized for use of the medical device (or other type of medical equipment), or execute the medical procedure (e.g., administer a drug). In the case that a match is not identified, error information (e.g., an error message) is delivered to halt the possible execution of an incorrect procedure (or procedures). The patient file 120 may be saved and maintained, for example, remotely on the centralized server 118 and the data repository 116.

Systems such as the medical information system 100 can provide numerous advantages, for example, accessible medical information is not the limited by the capacity of a barcode label (such as label 104). As such, storage is provided additional, pertinent patient information such as time of drug preparation, pharmacy comments, and clinician warnings. As a result, comprehensive patient information associated with the barcode label 104 can be retrieved and reviewed by a clinical staff (e.g. the anesthesiologist in the operation room) at a later time. By readily obtaining information from the barcode label 104, human error can be reduced in drug administration and the execution of other medical procedures.

Prior to administration of a drug, the data reader 106 (e.g., implemented as a handheld wired or wireless portable device) can be used by a healthcare professional for documenting medical information or procedure related to the patient. For example, after scanning the barcode label 104, the data reader 106 may deliver the patient related information, e.g., drug name in abbreviation, drug concentration, and the ID of a specific patient, time of the administration, to whom the drug is being administered or prescribed, to the patient record 120 through network 112. As such, the patient record 120 can be automatically updated and human error can be reduced in documenting medical procedures.

In some arrangements, the system 100 supports clinical coding (e.g., translation of medical terminology, which describes a patient's diagnosis, treatment or reason for seeking medical attention, into a coded format.), documentation and authorization of procedures by accurately and securely monitoring medication orders. As such, the system 100 can reduce medication errors and adverse events (e.g., avoid duplicate or unnecessary tests). Additionally, the system 100 can be configured to assist clinical diagnosis to promote use of preferred clinical practices, patient condition-specific guidelines, and population-based management of patient medical record.

Understandably, a relatively large amount of comprehensive patient and hospital information is shared on the network 112 and various techniques may be used for controlling and managing information and patient records (e.g., in a secured fashion). In one arrangement, the patient information stored at the server 118 or the repository 116 may be maintained through one or more Access Control Lists (ACLs), which control the granting of data access to protect records and to prevent, for example, accidental modification of the patient information or unauthorized access to the shared data. The system 100 may allow authorized users, e.g., users with appropriate permission, to manage, e.g., update individual patient files. When a particular patient record is modified by an authorized user, the system 100 bookkeeps copies of the original patient record and subsequent versions.

In one implementation, during preparation of a drug dispenser (e.g., the syringe 102) by a healthcare practitioner, he or she may document the procedure and access the patient's record (e.g., through network 112) by referencing an initial identifier, e.g., a number, that has been assigned to the patient, for example, at the time the patient was admitted into the hospital. The initial identifier may also be a unique patient identifier permanently assigned to a given patient to maintain the consistency of the patient records in the hospital. Updates of new information about the patient can be conveniently integrated into the shared information or data on the network 112 using the unique identifier. The patient identifier may be encoded into or be in the form of a barcode 105a or a multiple-digit string 105b as shown in FIG. 1. The barcode 105a can store information by encoding bars and spaces of various widths, arranged in a predetermined pattern. When the barcode 105a is scanned via a barcode scanning device (e.g., data reader 106), the encoded information is extracted and decoded. One or more barcode reading techniques and technology may be implemented, for example, laser scanners, charged coupled devices (CCD), a solid state imaging devices (SSI) or other technology may be utilized.

For the event that a patient has not been previously assigned a patient identifier (e.g., initial, unique identifier), a healthcare practitioner may generate a unique patient identifier (e.g., a barcode 105a or a multiple-digit string 105b, or both) for the patient prior to starting treatment, e.g., before administering drugs to the patient. This assigned unique identifier can be entered into the system 100 for later reference. The unique identifier can be used for a given patient even when the patient is at different locations at different times. For example, when the patient is moved among different departments of the hospital, the patient does not have to be assigned with multiple identifiers for use in different departments. Patient identification may also be implemented though other technologies such as radio signals, ultra-wide band signals, and readable electronic storage devices, such as smart cards, electronic chips, or magnetic storage media.

One or more designs and architectures may be for producing the data reader 106, for example a processed based design may be implemented such that the reader includes a processor 108 and a data storage 110. In some examples, the data reader 106 can be a hand-held wired/wireless barcode scanner, an optical character reader, a radio frequency (RF) reader for smart tags, or a speech recognition device. A medical personnel (e.g., a doctor or a nurse) at various locations may be allowed to input and retrieve drug related information of a patient by referencing the unique identifier 105a and 105b. For example, upon receiving the barcode 105a, the data reader 106 may initiate one or more processes that are executed by the processor 108. The processor 108 can include a communicator 109a for providing defined operations (e.g., specifying a user communication protocol for the data reader 106), an operating system, a line configuration, etc. The communicator 109a may also provide a reliable wired and wireless connection between the network 112 and each individual data reader device (e.g., the data reader 106). In some examples, hand-held barcode readers may operate in wireless networks according to IEEE 802.11g (WLAN) or IEEE 802.15.3 (Bluetooth), or in compliance with other similar protocols.

The processor 108 may also include a data logger 109b that allows the processor to exchange medical information (e.g., patient information, drug related information, etc.) with the centralized server 118 and the data depository 116. Additionally, the data reader 106 may also include other components such as a user interface 109c, e.g., a display, that allows the user to review information and to interact with other components of the data reader 106 or components of the system 100, such as the computer server 118 and the data depository 116. For example, the user can request through the user interface 109c a search for patient drug related information in the network 112.

A data storage 110 may be used for encoding (e.g., creating the barcodes for the patient) and decoding of the barcode on the barcode label 104. In some examples, the data storage 110 provides a limited data storage capability since the data reader 106 can retrieve comprehensive patient information that resides on the centralized server 118 and the data depository 116 through network 112.

The processor 108 may also incorporate a data formatter 109d that is configured to generate the patient barcode label 104. Such a barcode label can display basic patient and drug information, for example, in a tabulated form with multiple fields or any pre-programmed format. Pertinent information related to the drugs prescribed and delivered to a specific patient can be retrieved from the centralized server 118 and the data depository 116 through network 112. The information can include, for example, a dose of a prescribed drug, or the frequency of drug administration and drug concentration. In addition, information for drug contradiction and intuitive icons for indicating possible patient reaction to a specific drug can also be retrieved from the server 118 and, for example, be appended to the barcode label 104. In the example shown in FIG. 1, information embedded in the barcode label 104 represents that the patient should be advised not to drink alcohol after the administration of a specific drug along with possible drug side effects including dizziness and allergies. As such, when preparing the syringe 102 for the patient, a healthcare professional, possibly unfamiliar with the drugs or the patient, can be informed of possible patient drug reactions. Consequently, the healthcare professional can correctly educate and remind the patient to avoid undesired drug contradictions. Further, information recorded on the patient barcode label 104 may be determined based upon the nature of the patient's disease and/or requests made by certain departments or physicians.

In some arrangements, the users may be allowed to add and/or save comments to the patient barcode label 104 or into the patient's record 120 via the patient barcode label 104 (e.g., patient's unusual drug reaction and observation notes). In some examples, the data reader 106 may be configured to have a touch sensitive display (i.e., a touch screen) to work compatibly with the interface 109c. A text input module (not shown) can be implemented in the data reader 106 for the user to input data into the data reader 106 and the system 100. The test input module can include a soft keyboard, which is also referred to as an onscreen keyboard or software keyboard, to allow simple plain text input into the system 100. The soft keyboard sized and placed on the user display based on the design of the data reader. Other features, such as speech synthesis, word completion or prediction, may be also included in the data reader 106 or in other devices of system 100. The text inputs from the users may be stored, e.g., temporarily stored, in a separate file in the data storage 110 temporarily. In one example, the communicator 109a may be configured to send the file containing the text input from the user to the server 118 through the network 112, such that the notes can be combined and saved in the patient's record 120.

The system 100 described herein can be implemented in one computing system or a distributed computing system that includes multiple processors interconnected using communication networks.

Other data terminals, e.g., a computer 114 or computers at doctors' offices and nurses' stations, browser based appliances, or other displays can be connected with the data reader 106, thereby allowing display of patient information on a wide variety of devices. By referencing to the same patient identifier 105a and/or 105b at different locations and times, the data reader 106 of system 100 permits comprehensive patient drug administration audit trail to be retrieved, reviewed and updated with consistency and integrity.

Various types of network and computer architectures may be used for implemented systems such as the medical information system 100. For example, the illustrated system 100 could be considered a server/client software architecture that uses the shared network 112. In such an architecture, a client (e.g., referred to as a service requester) could interact with the system 100 by using a computer system 114, data reader 106, or other type of device. Correspondingly, the computer server 118 could be considered as the server of such an architecture (e.g., and referred to as service provider). In another type of exemplary architecture, a single computing device may provide the functionality of both client and server side operations. Other architectures types and styles may also be implemented, for example, more than two computing devices may be used for implementing the medical information system 100.

Patient records may be collected from one or more information sources and various hospital departments. The network 112, which can be a wired or a wireless distributed public or private network, may communication pathways for transferring the patient information. For example, by applying a common interface (e.g., protocol) among the devices connected to the network 112, patient information can be transferred to and from the centralized server 118, the data repository 116, and the geographically dispersed client-end devices (e.g., data reader 106). As such, the patient information including demographics, health and medical history, and in some examples, real-time clinical data obtained from one or more medical devices, may be collected and distributed using the network 112.

The network 112 may incorporate various networking techniques. For example, the network 112 may include a local area network (LAN), such as a company intranet or a home network. In some implementations, the network 112 may include a metropolitan area network (MAN) or a wide area network (WAN) such as the Internet. In other implementations, the network 112 may include a combination of one or more different types of network. For example, a LAN such as the home network may be connected to an external access network. In such cases, one or more gateway devices may act as interfaces between two different networks. In some arrangements, the network 112 may include one or a combination of: a point to point network, a broadcast network, a computer network, a power line network, an Asynchronous Transfer Mode (ATM) network, a Synchronous Optical Network (SONET), a Synchronous Digital Hierarchy (SDH) network, a wireless network and a wired network. If the network 112 is at least in part a wired network, the network 112 may include one or more of the following: coaxial cable, telephone wires, power line wires, twisted pair wires or any other form and type of wire. The topology of the network 112 may be a bus, star or a ring topology or any other topology capable of supporting the operations described herein.

In some implementations, the server 118 may be a single server while in other implementations, the server 118 may include multiple, logically-grouped servers (which may be referred to as a server farm). Servers included in such a logical group may be geographically dispersed or located relatively close in position. In some implementations, the server farm may also include a plurality of server farms. Servers within each farm may be heterogeneous and may operate according to one type of operating system platform (e.g., WINDOWS NT, manufactured by Microsoft Corp. of Redmond, Wash.), while one or more of the other servers 118 may operate on according to another type of operating system platform (e.g., Unix or Linux). The group of servers logically grouped as a farm may be interconnected using a wide-area network (WAN) connection or medium-area network (MAN) connection. For example, a farm may include servers 118 physically located in different continents or different regions of a continent, country, state, city, campus, or room.

In some arrangements, the server 118 may be referred to as a file server, application server, web server, or proxy server. The server 118 may have the capacity to function as either an application server or as an application server. In other implementation, the server 118 provides functionality of a web server.

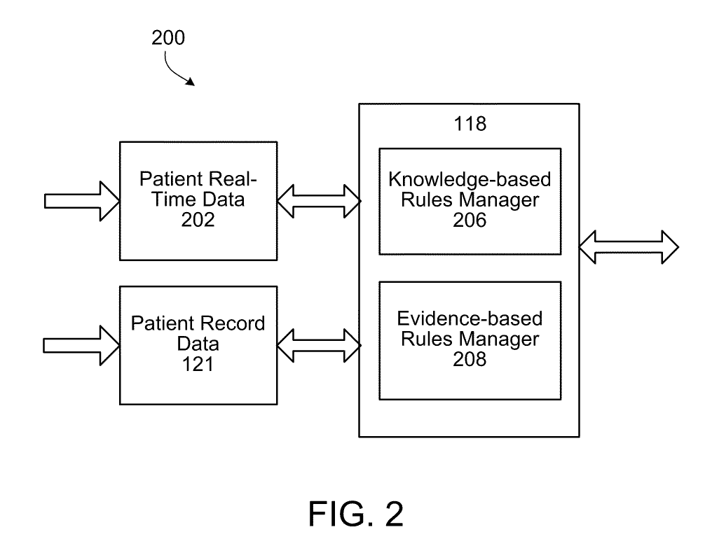

Referring to FIG. 2, the server 118 may be configured to dynamically receive patient information, such as measurement data 202 in real time. The measurement data 202 can be collected from various bedside monitors and medical devices. Updates of patient record data 121 (e.g., latest lab results) may also be periodically reported to the centralized server 118 and the data depository 116. In some examples, the server 118 may include knowledge-based rules manager software 206 for storing drug related information, such as drug side effects, drug contradiction, FDA drug alerts, patient care notes, clinical trial results, and other related information. When a service request from the data logger 109b of the data reader 106 for patient drug information and consultation is received, the knowledge-based rules manager software 206 can analyze, e.g., prioritize patient drug reactions, and subsequently generate warning information, e.g., in the form of graphical icons indicative of the reactions. The warning information may be timely transmitted to the data reader 106 and displayed to the user through data formatter 109d and interface 109c. For example, referring again to FIG. 1, the content of the barcode label 104 shows that the patient is prohibited to drink alcohol after being administered a specific drug. Possible drug side effects including dizziness and allergies can also be documented and appended to the label 104. By residing on the centralized server 118 and data depository 116, the knowledge-based rules manager software 206 can be used by and can facilitate a plurality of users and device terminals sharing the network 112. For example, a standardized clinical vocabulary can be used among all users and/or device terminals, and the rules manager software 206 so that communication can be readily made with each other.

In some implementations, if the patient is new to the system 100 and does not have a patient identifier assigned, the data logger 109b may automatically generate an identifier for the patient and sends the identifier to the server 118 through the network 112. After registering the patient information, the server 118 may access the knowledge-based rules manager software 206 to retrieve related information of the drug that the patient needs to be administered. The knowledge-based rules manager software 206 in this situation is implemented as a data store to provide general drug information in the absence of patient specific medical conditions.

In addition, the server 118 may include evidence-based rules manager software 208 that collects patient record data 120 and real-time data 202 from a plurality of medical devices. The collected data can be used to customize patient-drug reaction information. Some drug reactions are patient-specific and are associated with multiple patient variables, such as age, gender, medications history, and laboratory data. When a certain drug is being administered, it is desirable to take into consideration of the multiple patient variables while dynamically monitoring the patient conditions. For example, if a patient should be on a glucose control medication, and his blood glucose level was uncontrolled, a healthcare professional would switch the patient to another drug or medication and start controlling the medication. Also, medications with severe side effects and frequent side effects should be avoided. Evidence-based rules manager software 208 may also be configured to send alerts to related healthcare professionals upon detecting potentially dangerous drug contradictions, for example, by printing a warning message on the barcode label 104.

In some implementations, the server 118 may be configured to provide suggestions on adjustments in drug dosage or frequency based upon the dynamic patient conditions. The system 100 can improve health care services and outcomes in an efficient, reliable, and cost-effective manner. The server 118 may maintain and update rules in both of the rules manager software 206 and 208 upon receiving new drug related information and patient information/data from various sources, such as new research findings or new regulations from appropriate governmental agencies. Outdated rules may be purged out of the server 118 periodically by administrative departments or authorized parties.

The barcode label 104 can be produced using output devices, e.g., wired/wirelessly connected fax machines, scanners and printers, and the like that obtain information or instructions from the data logger 109b. A status summary listing all administered drug information regarding the patient can be readily retrieved from the centralized server 118 and the data depository 116 for use in billing, administration, diagnosis, or others.

In some arrangements, the data reader 106 is a wireless device, e.g., a wireless handheld scanner, to provide portability, and increased efficiency and accuracy, for example, when the patient is moved and/or requires multiple medical procedures, such as drug administrations. In addition, because the patient identifier 122 may be uniquely linked to the corresponding patient data record residing on centralized server 118 and data depository 116, patient information may be authenticated to prevent erroneous drug administration or other possible adverse events. In some examples, the system 100 can be configured to authenticate users by allowing users to log in a patient account using unique username and password. In some implementations, the system 100 can be configured to provide different levels of authorization to different groups of healthcare professionals. For example, some are allowed to access the stored information in the centralized server 118 for reading and writing, while others are only allowed to access the information for reading.

The server 118 may also incorporate an expert system to receive user input in some instances (e.g., physician notes for specific patients). A more sophisticated fuzzy logic expert system can also be coupled with a neural network that learn over time how some treatment process should perform and what conditions are anomalies. Fuzzy logic and neural networks may be powerful tools in data mining the data repository 116 as any customized statistical or mathematical technique may be applied to determine correlations, find optimum process conditions, predict instabilities or runnability problems, and the like. Sample methods may include statistical analysis, such as regression or time-series analysis, signal processing techniques, such as autocorrelation analysis, and other methods.

The expert system may be an intelligent tool to automatically check data integrity as the data is recorded in the centralized data repository 116 and may be adapted to tag the record for human intervention if the data was suspect. If a patient data record 120 violates a set of particular rules or was determined to be a statistical anomaly, the expert system may flag the record and send e-mail or other communications to appropriate staff for intervention. If the record 120 is found to be erroneous, the system may allow a staff to manually correct the error. If the record 120 was correct, a tag may be marked in the centralized data repository 104 to signal to the expert system that the record 120 has been checked and verified for accuracy.

The expert system may be intelligent in at least two aspects. First, human experts (e.g., a surgeon or physician) may impart their learning to the expert system through a fuzzy-rule-based inference system (not shown). There are many types of errors in a machine process log that humans may quickly and easily detect upon inspection. A list of known errors and inconsistencies would be compiled into fuzzy if-then rules, and the agent may automatically navigate a large amount of data and check the data using the expert-based rules. Second, the expert system may use a neural network to learn patterns in the data. Deviations from learned patterns may be flagged as anomalies. The neural network may be trained with historical data and may be re-trained after a given time period to be updated with the most current patient information.

In some examples, the fuzzy logic expert system can also be integrated with the system 100 to examine the correctness of the user inputs into the system 100. For example, upon detecting errors like unordered drug, inappropriate dosage or formulation, or technical errors in preparation or administration (e.g., wrong infusion flow rate or wrong diluents), the fuzzy logic expert system may reject the input and deliver, e.g., display, warning messages to the healthcare professional to check the correctness of the inputs. As such, data readability and interpretation in the system 100 can be greatly enhanced, thereby improving the efficiency of the workflow in a healthcare environment.

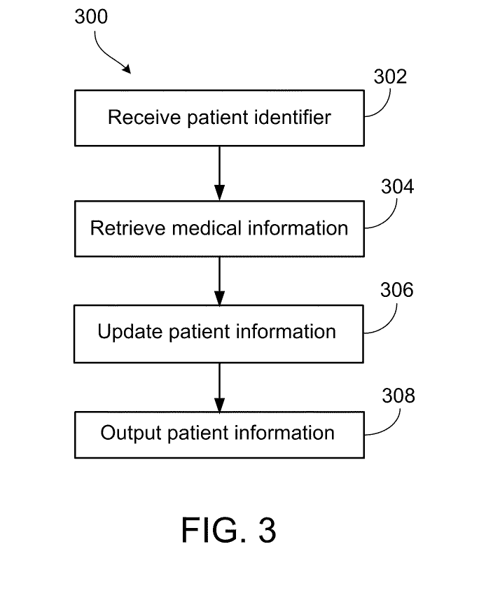

FIG. 3 is a flow chart of some operations performed by the data logger software 109b of the data reader 106. Upon receiving 302 the patient identifier 105a and/or 105b (shown in FIG. 1), the data logger 109b polls the server 118 to retrieve 304 medical information (e.g., patient, drug related information, etc.). Subsequently, the data logger 109b serves as a bridge between the process-related variables (e.g., operator inputs) and the centralized server 118. In particular, the healthcare practitioner administering the drugs may be prompted to enter the time of drug preparation, dosage, and concentration, and in some examples, brief notes. Information is uploaded and saved in the server 118 and data repository 116. When there is a need to review the saved information, the information can be downloaded to the data storage 110. As such, the data logger 109b updates 306 patient information at the server 118 with a new drug administration record by referencing the patient identification (e.g., patient identifier 105a, 105b). Optionally, the retrieved patient information may be output 308 by the data reader 106 (e.g., during the same time period). The patient record 120 in the centralized server 118 and data depository 116 may be correspondingly updated for data archival and management purposes.

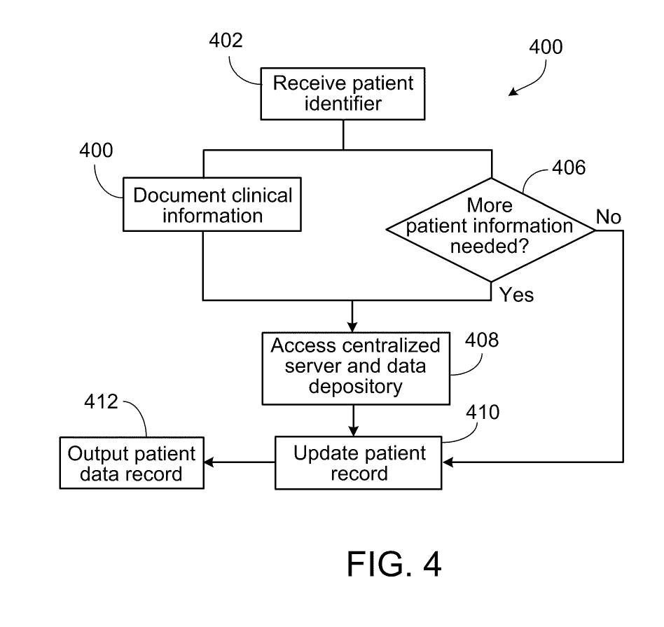

Referring now to FIG. 4, a flowchart 400 represents a particular arrangement of operations in patient information documentation and collection process that may be performed by the data reader 106. Operations include receiving 402 a patient identifier (e.g., the barcode 105a, multiple-digit string 105b, or both). Upon receiving the identifier, the data reader 106 may initiate the data logger 109b to document 404 clinical information, based on the patient identifier in the server 118. Additional information such as date, time, and other pertinent information can also be properly documented. As such, a patient-related event or any patient specific data can be registered in the centralized server 118 and the data repository 116. For example, when a patient is being transferred to an operating room, the physicians may only need to check pertinent drug consumption history from patient barcode label 104 for diagnostic purposes. In the meantime, the system 100 together with other processes can enable timely and accurate record keeping during the course of complicated surgical/operative procedures.

The data reader 106 then determines 406 whether more patient information is needed. If needed, a healthcare profession can scan the barcode label 104 appended on various medical devices using the date reader 106 to access 408 the centralized server and data repository for retrieving the additionally needed information from an appropriate patient record. In some implementations, the data reader 106 may communicate with and access the centralized server 118 via the network 112. The centralized server 118, as described in FIG. 2, may process real-time measurement data 202 and continuously consolidate such information with the comprehensive patient record (e.g., patient record 120) in a proper format. In some implementations, a medical content integration system (not shown) may be implemented on the server 118 for generally collecting, classifying and updating patient information, smart alarms, clinical publications and other types of information that impart medical knowledge. For example, in a dynamic clinical setting (e.g., a hospital) where time-pressed medical doctors or practitioners need reliable information immediately to diagnose and treat patients, the medical content integration service system may be deployed across organizational and repository boundaries with improved search capabilities and integrated access. As a result, the hospital can provide a timely, reliable, substantially complete and context-relevant information service.

It is also useful to initiate the user interface 109c to prompt a user to input additional information either manually or automatically via other appropriate electronic devices. This additional information may become part of a data record that the data logger 109b records for each logging process.

Operations may further include updating 410 a patient data record. After retrieving certain patient data from the server 118, the healthcare professionals can manipulate and edit the data in a variety of ways to update the patient data record. In some implementations, such outputting, displaying or updating may be done using various devices (e.g. computers, wired/wireless fax machines, scanners and printers) that are connected with the data logger 109b for billing, administrative and diagnostic purposes. The updated patient data record can be stored back into the server 118.

In addition, the data reader 106 can also display 412 the retrieved or the updated patient data record to the user to, e.g., assist the user's performance of medical procedures.

The apparatus, methods, flow diagrams, and structure block diagrams described in this patent document can be implemented in computer processing systems including program code comprising program instructions that are executable by the computer processing system. Other implementations can also be used. Additionally, the flow diagrams and structure block diagrams described in this patent document, which describe particular methods and/or corresponding acts in support of steps and corresponding functions in support of disclosed structural means, can also be utilized to implement corresponding software structures and algorithms, and equivalents thereof.

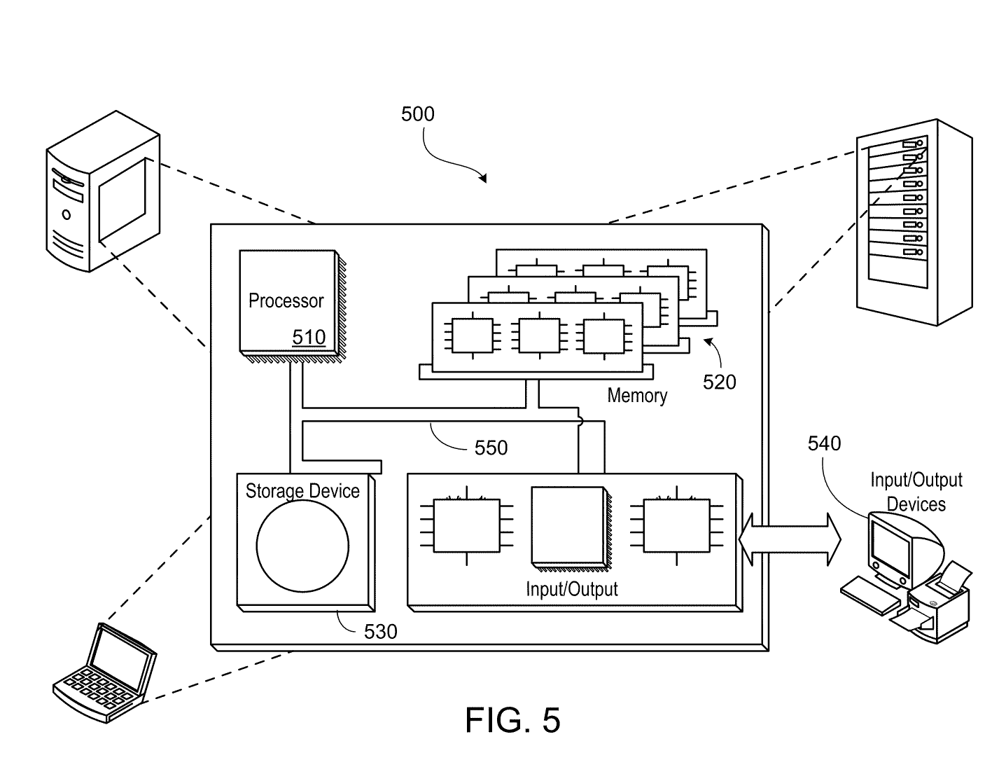

FIG. 5 is a schematic diagram of an example computer processing system 500. The computer processing system 500 can be used for practicing operations described above. The system 500 can include a processor 510, a memory 520, a storage device 530, and input/output devices 540. Each of the components 510, 520, 530, and 540 are interconnected using a system bus 550. The processor 510 is capable of processing instructions within the system 500. These instructions can implement one or more aspects of the systems, components and techniques described above. In some implementations, the processor 510 is a single-threaded processor. In other implementations, the processor 510 is a multi-threaded processor. The processor 510 can include multiple processing cores and is capable of processing instructions stored in the memory 520 or on the storage device 530 to display graphical information for a user interface on the input/output device 540.

The memory 520 is a computer readable medium such as volatile or non volatile that stores information within the system 500. The memory 520 can store processes related to various functionality, for example. The storage device 530 is capable of providing persistent storage for the system 500. The storage device 530 can include a floppy disk device, a hard disk device, an optical disk device, or a tape device, or other suitable persistent storage mediums. The storage device 530 can store the various databases described above. The input/output device 540 provides input/output operations for the system 500. The input/output device 540 can include a keyboard, a pointing device, and a display unit for displaying graphical user interfaces.

The computer system 500 illustrates one example of a computing device. In general, embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art can effect alterations, modifications and variations to the examples without departing from the scope of the invention.

What is claimed is:

1. A computer implemented method comprising:
receiving a unique patient identifier for a patient;
using the unique patient identifier to retrieve medical information associated with the patient from a centralized information source that includes a patient record containing the medical information; and
after performing a medical procedure on the patient based on the retrieved medical information, updating the patient record in the centralized information source to reflect the performed medical procedure.

2. The computer implemented method of claim 1, further comprising:
delivering medical information associated with the patient to the centralized information source; and
applying one or more rules to the received information to update the delivered medical information associated with the patient.

3. The computer implemented method of claim 2, wherein the medical information comprises patient real-time data and patient record data.

4. The computer implemented method of claim 1, further comprising printing the medical information in a machine-readable form.

5. The computer implemented method of claim 1, wherein the medical information includes information representative of reactions to an administered drug.

6. The computer implemented method of claim 5, wherein the reaction information is represented in a graphical form.

7. The computer implemented method of claim 1, wherein the unique patient identifier is received from a barcode scanner.

8. The computer implemented method of claim 7, wherein using the unique patient identifier to retrieve medical information associated with the patient includes decoding the unique patient identifier received from a barcode scanner.

9. The computer implemented method of claim 7, wherein using the unique patient identifier to retrieve medical information associated with the patient includes accessing the centralized information source with the unique identifier.

10. A system, comprising:
a data reader in communication with a centralized server and a data repository for storing and managing medical information, the data reader being configured to receive a machine-readable patient identifier from at least one device disposed at a location different from the centralized server and the data repository, the data reader being further configured to exchange the medical information with the centralized server and the data repository based on the patient identifier.

11. The system of claim 10, wherein the data reader is implemented in a portable device.

12. The system of claim 10, wherein the data reader comprises:
a data storage; and
a processor configured to initiate one or more processes to exchange the medical information with the centralized server and the data repository based on the received patient identifier.

13. The system of claim 10, wherein the data reader includes a scanner and the machine-readable patient identifier is a barcode.

14. A computer-readable medium for storing instructions that are executable by a computer, the execution of the instructions causes the computer to:
receive a unique patient identifier for a patient;
use the unique patient identifier to retrieve medical information associated with the patient from a centralized information source that includes a patient record containing the medical information; and
after performing a medical procedure on the patient based on the retrieved medical information, update the patient record in the centralized information source to reflect the performed medical procedure.

15. The computer-readable medium of claim 14 further comprising causing the computer to
deliver medical information about the patient to the centralized information source; and
apply one or more rules to update the medical information based on the delivered information.

16. The computer-readable medium of claim 14, wherein the medical information includes patient real-time data and patient record data.

17. The computer-readable medium of claim 14 further comprising causing the computer to print the medical information in a machine-readable form.

18. The computer-readable medium of claim 14, wherein medical information includes possible patient reactions to a drug and drug contradiction information.

19. The computer-readable medium of claim 18, wherein the possible patient reactions are presented in a graphical form.

20. The computer-readable medium of claim 14, wherein the unique patient identifier is received by scanning a barcode label on a device remote to the centralized information source.

21. The computer-readable medium of claim 20, wherein retrieving the medical information comprises decoding the barcode label or retrieving the information from the centralized information source to display on a scanner based on the unique identifier.

22. The computer-readable medium of claim 20, wherein retrieving the medical information comprises accessing the centralized information source with the unique identifier.
